(19) United States
(12) Patent Application Publication
(10) Pub. No.: US 2018/0022528 A1
(43) Pub. Date: Jan. 25, 2018

(54) Mixing and Dispensing Device and Method for Preparing and Applying an Adhesive Consisting of at Least Two Components

(71) Applicant: Henkel IP & Holding GmbH, Duesseldorf (DE)

(72) Inventors: David Farrell, Co. Mayo (IE); Michael Anthony Doherty, Co. Kildare (IE); Bryan Brady, Dublin (IE)

(21) Appl. No.: 15/724,334

(22) Filed: Oct. 4, 2017

Related U.S. Application Data
(63) Continuation of application No. PCT/EP2016/058263, filed on Apr. 14, 2016.

(30) Foreign Application Priority Data
Apr. 15, 2015 (DE) 102015206757.2

(51) Int. Cl. B65D 81/32; B05C 17/005; C09J 133/12; B65D 83/00

(52) U.S. Cl. CPC B65D 81/3255; B65D 83/0033; B05C 17/00559; B05C 17/00569; B05C 17/00576; C09J 133/12

(57) ABSTRACT

A mixing and dispensing device (1) for preparing and applying an adhesive consisting of at least two components, comprises a syringe body (2) which encloses a substantially cylindrical cavity (3), wherein the cavity (3) is divided into at least two chambers separated from each other by a movable separating element (6), wherein—a first chamber (4) has a first component (13) of the adhesive and—a second chamber (5) has a second component (14) of the adhesive, wherein a flow path (11) between the first chamber (4) and the second chamber (5) can be released by moving the separating element (6).

The present invention relates to a mixing and dispensing device for preparing and applying an adhesive consisting of at least two components. The present invention further relates to a method for preparing and applying an adhesive consisting of at least two components.

An adhesive is understood here and in the following to mean a mainly organic process material which is used for adhesively bonding elements and/or for sealing.

Preparing adhesives comprising a plurality of components in a cartridge system is known, for example from EP 2 497 721 A1. In this case, each component is stored in a cartridge and prepared individually. The components are first mixed during application, in a mixing device that is placed on the cartridge system. A system of this kind has the advantage that the components that are separate from one another can be stored for a very long time. However, cartridge systems are relatively expensive. In addition, each application leads to a loss of material owing to residue remaining in the mixing device, and this is associated with very high material costs and even with financial losses in certain applications, for example in the field of dentistry.

In contrast, single-component adhesives are easy to use but often cannot be stored for very long.

One problem of the present invention is that of providing a mixing and dispensing device for preparing and applying an adhesive that consists of at least two components (“two component adhesive”), is user-friendly and at the same time has a very good storage life.

This problem is solved by the subject matter of the independent claims. Further embodiments are the subjects of the dependent claims.

According to one aspect of the invention, a mixing and dispensing device is provided for preparing and applying an adhesive that consists of at least two components and comprises a syringe body that encloses a substantially cylindrical cavity. The cavity is divided into at least two chambers that are separated from one another by a movable separating element, a first chamber comprising a first component of the adhesive and a second chamber comprising a second component of the adhesive. A flow path can be released between the first chamber and the second chamber by moving the separating element.

The mixing and dispensing device thus comprises at least two chambers, but can also comprise more than two chambers, for example if more than two components are intended to be provided separately from one another. Said device has the advantage of a very good storage life since the at least two components are kept separate from one another. The adhesive is only prepared immediately before use by mixing the components and is then readily available in the mixing and dispensing device and can be used as a single-component adhesive. The mixing and dispensing device is thus also very user-friendly.

The mixing and dispensing device can be particularly advantageously used if the individual components are liquid and have a low viscosity. However, it is also conceivable to use said device for other systems. For example, a component may also be present in powder form or at least one liquid component may have a high viscosity.

It has become apparent that adhesives prepared in the mixing and dispensing device can still be used 24 hours after they have been prepared. The pot life of the adhesive is thus significantly increased in comparison with the known multi-component systems.

In one embodiment, the flow path is formed between the separating element and an inner wall of the syringe body. For this purpose, the flow path can be formed for example in an outward bulge of the syringe body. In this embodiment, the wall thickness of the syringe body can be the same in all regions. In an alternative embodiment, the flow path is formed in a channel inside a wall of the syringe body. In this embodiment, the wall thickness of the syringe body is accordingly reduced in one region such that a flow path is formed in said region.

In one embodiment, the mixing and dispensing device further comprises a piston for moving the separating element in the longitudinal direction of the syringe body and for dispensing adhesive. Syringes comprising pistons of this kind are known in particular from the field of medicine. The piston is pushed into the syringe body in order to move the separating element such that the flow path is released. Pushing the piston again forces the component located in the chamber closest to the piston into the other chamber, therefore allowing the components to be completely mixed. Pushing the piston yet again causes ready-mixed adhesive to be dispensed. Operating the piston is highly intuitive, and therefore the mixing and dispensing device is easy to use.

In one embodiment, the first component is formed as a liquid having a first color and the second component is formed as a liquid having a second color. This has the advantage that the mixing of the components can be visually monitored by the user when using a typical transparent syringe body. It can also be determined whether residues of a component are left in a chamber.

In one embodiment, the mixing and dispensing device comprises a dispensing opening at one end of the syringe body, a mixing device being arranged in the region of the dispensing opening. The mixing device, which can be formed for example as a static mixer, can improve the intermixing process, in particular for systems in which at least one component has a relatively high viscosity.

In one embodiment, the mixing and dispensing device comprises a dispensing opening at one end of the syringe body, which opening can be closed by a stopper. This has the advantage that a sealed closure of the mixing and dispensing device is possible, and therefore the pot life of the ready-to-use mixture is increased.

The adhesive can be in particular an anaerobically curing adhesive or a methyl methacrylate adhesive.

According to another aspect of the invention, a method is provided for preparing an adhesive consisting of at least two components, the method comprising the following:
providing the described mixing and dispensing device;
moving the separating element and releasing a flow path between the first chamber and the second chamber;
mixing the first component of the adhesive with the second component of the adhesive.

The mixing process can be carried out in particular passively by waiting or actively by shaking and/or pressing one component into the other chamber.

The method has the advantage that it is very simple to carry out, in particular by pushing a piston into the syringe body. Said method can be carried out immediately before using the adhesive, although the adhesive can still be used 24 hours after the method has been carried out depending on the chemical system used.

Embodiments of the invention are described in more detail in the following with reference to drawings, in which:

### BRIEF DESCRIPTION OF THE DRAWINGS

FIG. 1 is a schematic view of a mixing and dispensing device for an adhesive according to a first embodiment of the invention in a first position of use;

FIG. 2 is a schematic view of the mixing and dispensing device according to FIG. 1 in a second position of use;

FIG. 3 is a schematic view of the mixing and dispensing device according to FIG. 1 in a third position of use;

FIG. 4 is a schematic perspective view of the syringe body of the mixing and dispensing device according to FIG. 1;

FIG. 5 is another schematic perspective view of the syringe body of the mixing and dispensing device according to FIG. 1;

FIG. 6 is a schematic view of the syringe body of the mixing and dispensing device according to FIG. 1 in a longitudinal cross section;

FIG. 7 is a schematic view of a detail from FIG. 6; and

FIG. 8 is a schematic view of a detail of a mixing and dispensing device according to a second embodiment of the invention.

### DETAILED DESCRIPTION

FIG. 1 shows a mixing and dispensing device 1 for an adhesive that, in the example shown, consists of two components. The mixing and dispensing device 1 comprises a syringe body 2 comprising a wall 12 that encloses a substantially cylindrical cavity 3. The cavity 3 is divided into a first chamber 4 and a second chamber 5 by means of a separating element 6 that can be moved longitudinally inside the syringe body 2.

The first chamber 4 is filled with a first component 13 of the adhesive and the second chamber 5 is filled with a second component 14 of the adhesive. In the first position of use of the mixing and dispensing device 1 shown in FIG. 1, the separating element 6 rests tightly against the inside of the wall 12, meaning that it is not possible to exchange gas or liquid between the first chamber 4 and the second chamber 5.

The mixing and dispensing device 1 further comprises a piston 7 which can be pushed into the syringe body 2. In the first position of use shown in FIG. 1, most of the piston 7 protrudes out of the cavity 3 and only the front end 8 thereof is pushed into the cavity 3. The front end 8 of the piston 7 and the separating element 6 define the second chamber 5. The first chamber 4 is delimited by the separating element 6 and the front end 18 of the syringe body 2.

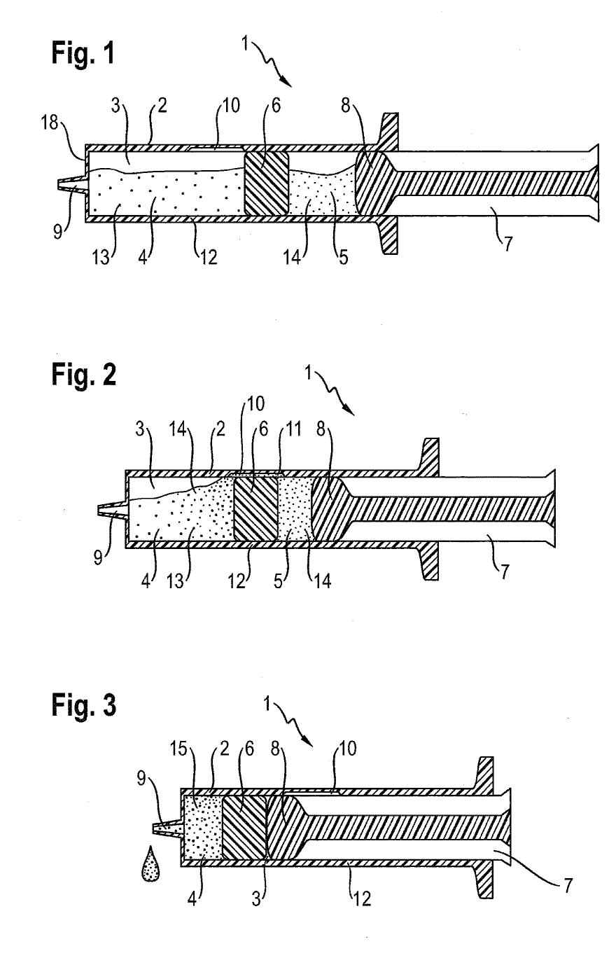

A channel 10 is arranged in the wall 12 of the syringe body 2 at a point in a central region. The channel 10 is formed by a reduction in the wall thickness. A flow path can be formed by the channel 10 when the separating element 6 is pushed to the level of the channel 10. This is shown in FIG. 2.

The mixing and dispensing device 1 further comprises a dispensing opening 9 at the front end 18 thereof, by means of which opening ready-mixed adhesive can be dispensed by applying pressure to the piston 7. A stopper (not shown) can be placed on the dispensing opening 9 in the form of a tip as required in order to close the cavity 3 in an airtight manner. Ready-prepared adhesive can then be stored for 24 hours, for example.

The mixing and dispensing device 1 can be stored in the first position of use. Long-term storage is possible owing to the separation of the components 13, 14.

FIG. 2 shows the mixing and dispensing device 1 in a second position of use. This is achieved by the piston 7 being pushed some way into the cavity 3. The second component 14 located in the second chamber 5 or possibly also gas located in the second chamber 5 is first compressed by means of the pressure on the piston 7. As a result, the pressure in the second chamber increases and applies a force on the separating element 6. If said force is sufficiently large, the separating element 6 is also pushed in the longitudinal direction of the syringe body 2 and reaches the level of the channel 10. The separating element 6 now no longer fills the entire cross section of the cavity 3. As a result, a flow path 11 is formed by the channel 10, by means of which flow path the second component 14 flows into the first chamber 4. Here, said second component is mixed with the first component 5 and reacts therewith to form the ready-prepared adhesive 15.

By applying pressure to the piston 7, said piston is guided as far as the separating element 6 such that the total content of the second chamber 5 enters the first chamber 4.

Mixing the components 13, 14 can be assisted by waiting or shaking.

The second position of use is accordingly used for the preparation of the adhesive from the components 13, 14.

FIG. 3 shows the mixing and dispensing device 1 in a third position of use, which is used for dispensing the prepared adhesive 15. If the preparation of the adhesive 15 is complete, said adhesive can be pressed out of the syringe body 2 through the dispensing opening 9 by means of further pressure on the piston 7. In the process, the piston 7 pushes the separating element 6 along.

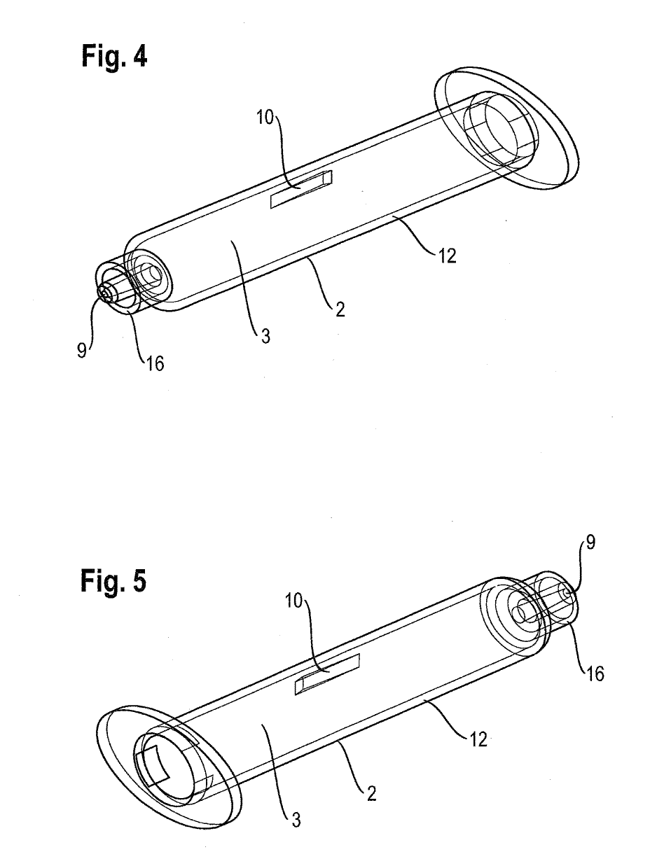

FIGS. 4 and 5 are two perspective views of the syringe body 2 itself. In this view, a rim 16 is arranged around the dispensing opening 9, on which rim a stopper for closing the mixing and dispensing device 1 can be placed.

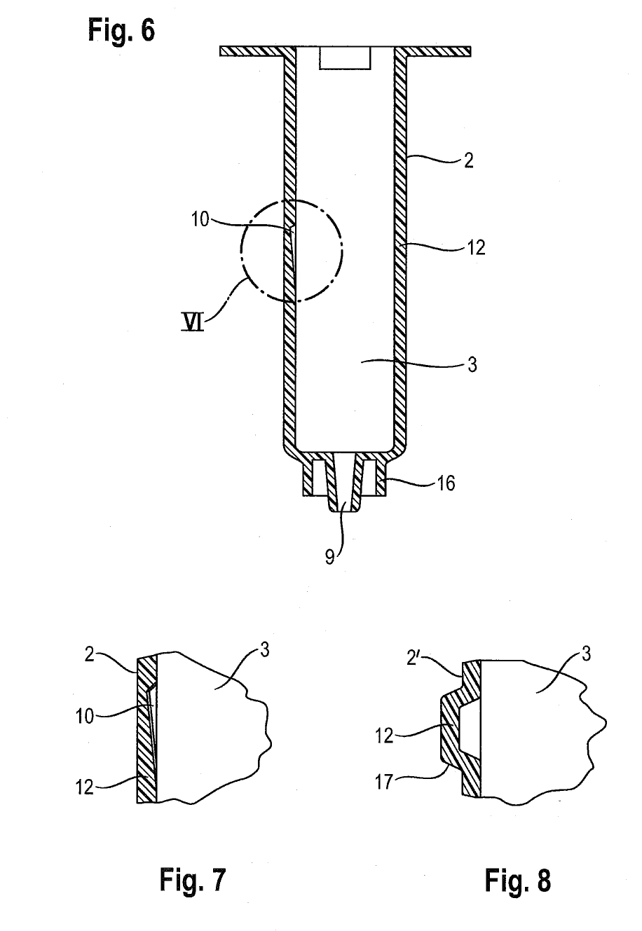

FIG. 6 is a longitudinal cross section of the syringe body 2. In this case, it can be seen that the longitudinal cross section of the channel 10 is triangular in this embodiment. However, said channel can also be rectangular or semi-oval, for example. Said channel is shown in detail in FIG. 7. In this case, it can be seen that the channel 10 is formed by a locally reduced wall thickness of the wall 12.

FIG. 8 shows an alternative embodiment of the flow path. In this case, the wall 12 has an outward bulge 17 and the wall thickness can be uniform in this embodiment.

In principle, the mixing and dispensing device 1 is suitable for different types of adhesive systems that are mixed from at least two components.

### EXAMPLES

### Example 1

The mixing and dispensing device 1 can be used for a methyl methacrylate adhesive, for example. One example is an adhesive having the following composition:

Chamber 1: monomer (triEGMA)+initiator (peroxide), 2%+yellow pigment Chamber 2: monomer (HEMA)+sPP (syndiotactic polypropylene) accelerator Cu (BF4)2, 1% in a ratio of 2:1.

The mixing and dispensing device comprising said adhesive system demonstrates good stability during storage. If the content of the second chamber is pressed into the first chamber, the mixture turns green. The degree of mixing can be checked by means of the color. The mixture starts to anaerobically cure after approximately 25 minutes, although the supernatant liquid can still be used after 24 hours when the mixing and dispensing device is stored upright on the stopper.

It would also be conceivable for this system to provide the total monomer together with the accelerator in one chamber, while the second chamber only contains the initiator.

### Example 2

The following composition is an example of an anaerobically curing adhesive:

Chamber 1: monomer (triEGMA)+initiator (peroxide), 1%+reducing agent, 1%

Chamber 2: monomer (HEMA)+sPP (syndiotactic polypropylene) accelerator MX2, 0.5%

in a ratio of 2:1.

The mixing and dispensing device comprising this adhesive system demonstrates good stability during storage. The mixture starts to anaerobically cure after approximately 25 minutes, although the supernatant liquid can still be used after 24 hours when the mixing and dispensing device is stored upright on the stopper.

### LIST OF REFERENCE SIGNS

1 mixing and dispensing device

2, 2′ syringe body

3 cavity

4 first chamber

5 second chamber

6 separating element

7 piston

8 front end

9 dispensing opening

10 channel

11 flow path

12 wall

13 first component

14 second component

15 adhesive

16 rim

17 bulge

18 front end

1. A device for storing, mixing and dispensing a two component adhesive, the device comprising:
a syringe body having a dispensing end and an opposing sealable end, the syringe body having an inner wall defining a substantially cylindrical cavity, the syringe body having a fluid flow path between the dispensing end and the sealable end, the cavity being fluidly connected to a dispensing opening at the dispensing end;
a piston disposed in the cavity adjacent the sealable end for movement toward the dispensing end by a user;
a separating element disposed within the cavity, the separating element and cavity defining a first chamber between the separating element and dispensing end and a second chamber between the separating element and piston, the separating element movable from a first position between the flow path and piston, through a second position adjacent the flow path to a third position between the flow path and the dispensing end, wherein the first chamber and second chamber are fluidly separated by the separating element in the first position, the first chamber and second chamber are fluidly connected by the flow path when the separating element is adjacent the second position and the first chamber and second chamber are fluidly separated by the separating element in the third position.

2. The device according to claim 1, wherein the first chamber contains a first component of the two component adhesive and the second chamber contains a second component of the two component adhesive.

3. The device according to claim 1, wherein the fluid flow path is external to the inner wall of the syringe body.

4. The device according to claim 1, wherein the fluid flow path is defined by a channel in the inner wall of the syringe body.

5. The device according to claim 1, wherein the fluid flow path is formed in an outward bulge of the syringe body.

6. The device according to claim 1, wherein movement of the piston toward the dispensing end moves the separating element from the first position towards the third position.

7. The device according to claim 1, wherein the first chamber contains a liquid first component of the two component adhesive having a first color and the second chamber contains a liquid second component of the two component adhesive having a second color.

8. The device according to claim 1, further comprising a mixing device fluidly connected to the dispensing opening.

9. The device according to claim 1, further comprising a stopper for fluidly sealing the dispensing opening.

10. The device according to claim 1, containing a two component anaerobically curing adhesive.

11. The device according to claim 1, containing a two component methyl methacrylate adhesive.

12. The device according to claim 1, having a singular syringe body.

13. A method for preparing a two part adhesive; comprising:
providing the device according to claim 1, wherein the first chamber contains a first component of the two component adhesive and the second chamber contains a second component of the two component adhesive;
moving the separating element from the first position to the second position to fluidly connect the first chamber and the second chamber; and
mixing the second component of the two component adhesive with the first component of the two component adhesive in the first chamber.

14. The method of claim 13, further comprising the step of moving the piston toward the dispensing end.

15. The method of claim 13, further comprising the step of moving the piston toward the dispensing end to displace the separating element from the first position toward the second position.

16. The method of claim 13, further comprising the step of moving the piston toward the dispensing end to displace the separating element from the first position toward the second position and discharge mixed two component adhesive from the dispensing opening.
